(19) United States
(12) Patent Application Publication
(10) Pub. No.: US 2008/0193361 A1
(43) Pub. Date: Aug. 14, 2008

(54) Ultra-Hard Materials

(76) Inventor: John Edward Lowther, Edenvale (ZA)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/908,971

(22) PCT Filed: Mar. 17, 2006
(86) PCT No.: PCT/IB2006/000593

§ 371 Date: Dec. 26, 2007

(30) Foreign Application Priority Data
Mar. 18, 2005 (ZA) 2005/02309

(51) Int. Cl. C01B 21/20

(52) U.S. Cl. 423/385

(57) ABSTRACT

An ultra-hard material comprising at least three elements and having a Knoop hardness of at least 25 GPa and the formula: Rₓ O_{y} N_{z} having a crystallographic structure in which the average anion co-ordination number is 6 or more and wherein: R is an element selected from the group consisting of titanium, hafnium, zirconium, tantalum, niobium and tungsten, x is an integer from 1 to 3, y is an integer from 0 to 5, and z is an integer from 0 to 5, provided y and z cannot both be zero. Examples of such ultra-hard materials are TaON and TaZrO₃N.

### BACKGROUND OF THE INVENTION

This invention relates to ultra hard materials.

Ultra hard materials may be defined as those materials that have a Knoop hardness greater than about 25 GPa, or a bulk modulus greater than about 300 GPa. Examples of such materials which find extensive use in industry are diamond, which has a bulk modulus of about 445 GPa and a Knoop hardness of about 90 GPa, and cubic boron nitride which has a bulk modulus of about 370 GPa and a Knoop hardness of about 47 GPa. Such materials are referred to hereinafter as established ultra hard materials.

The search for new ultra hard materials is motivated by several needs. The first of these is to identify materials the properties of which exceed those of the established ultra hard materials, especially with respect to hardness and bulk modulus. The second motivation is to identify ultra hard materials which may be made more economically than the established ultra hard materials, especially with respect to the costs of raw materials. A third motivation is to identify ultra hard materials which may be made at less severe conditions of temperature and/or pressure than the established ultra hard materials. A further motivation is to identify ultra hard materials that may be used to machine workpieces for which the established ultra hard materials are either unsuitable or inferior, for example on account of chemical incompatibility.

Thus, there is always a need for new and improved ultra hard abrasive materials.

### SUMMARY OF THE INVENTION

According to a first aspect of the invention, there is provided an ultra hard material comprising at least three elements and having the general formula:

Rₓ O_{y}N_{z}

having a crystallographic structure in which the average anion co-ordination number is 6 or more and wherein:
R is an element selected from the group consisting of titanium, hafnium, zirconium, tantalum, niobium and tungsten,
x is an integer from 1 to 3,
y is an integer from 0 to 5, and
z is an integer from 0 to 5
provided y and z cannot both be zero.

The element R may be a single element or two or more of the elements described above. The preferred elements are tantalum, zirconium or a combination thereof, i.e. both elements.

The ultra hard material must comprise at least three elements (i.e. a ternary or higher order compound). Examples of hard materials of the invention are the ternary material TaON and the quaternary material, TaZrON, and TaZrO₃N.

The crystallographic structure of the material is one in which the average anion co-ordination number is 6 or more, typically about 8 or about 9. Examples of suitable crystal structures are cubic, orthorhombic and mineral structures such as cotunnite.

The material of the invention is an ultra-hard material having a Knoop hardness of at least 25 GPa and preferably at least 30 GPa.

According to a second aspect of the invention, there is provided a method of making an ultra-hard material as described above which includes the steps of:
(i) providing a source material having the composition necessary to produce the desired ultra-hard material, and
(ii) subjecting the source material to elevated temperature and pressure conditions suitable to produce the material.

The method of the invention thus involves the transformation of a source material into the desired ultra-hard material under elevated temperature and pressure conditions. Typically, the elevated temperature will be greater than 500° C. and the elevated pressure will be higher than 4 GPa, more typically a temperature in the range 1000° C. to 1500° C. and a pressure in the range 5 to 30 GPa.

In one form of the invention, the source material is placed in a reaction vessel, the reaction vessel placed in an ultra-high pressure apparatus, the contents of the reaction vessel subjected to the required elevated temperature and pressure conditions, and the ultra-hard material thus produced recovered from the reaction vessel.

In another form of the invention, the source material is subjected to the required elevated temperature and pressure conditions by shock wave treatment.

The source material may have the same chemical structure as the ultra-hard compound material to be produced, but will have a less hard crystallographic structure, e.g. monoclinic. An example of such a source material is monoclinic TaON which is known in the art. Alternatively, the source material may be produced by mixing the necessary components for the ultra-hard material to form an intimate mixture which is then subjected to the conditions of elevated temperature and pressure mentioned above.

The invention provides, according to another aspect, the use of an ultra-hard material as described above, in an abrasive, cutting, milling, drilling, or like application.

### DESCRIPTION OF EMBODIMENTS

Within a crystalline structure, there are two types of lattice site, namely cationic sites and anionic sites. The cationic sites are generally occupied by metallic elements such as sodium, potassium, magnesium and iron. The anionic sites are generally occupied by non-metallic elements such as chlorine, oxygen and nitrogen. Surrounding each cationic site is a number of anionic sites, and surrounding each anionic site is a number of cationic sites. The number of anionic sites surrounding a cationic site is referred to as the anion co-ordination number. The relationship between crystallographic structures and co-ordination numbers is discussed in many standard texts on structural inorganic chemistry (see for example, “Structural Inorganic Chemistry” by A. F. Wells, published by the Clarendon Press).

The source material may be in the form of a compound, alternatively, the components for producing a hard material may be mixed together to form an intimate mixture. The mixing may be done with dry components in particulate form, with the components in a slurry form, using a sol-gel technique or any other suitable method.

The material of the invention may be used in monolithic form as a cutting tool insert, an insert for a drill bit or the like. To facilitate the use of the material in these types of application, monolithic material may be shaped by any appropriate method, such as laser cutting and grinding. The material of the invention may also be crushed into particulate form and used as an abrasive for polishing and lapping. In particulate form, the material of the invention may be bonded into a block or piece of an appropriate shape using a bonding agent which may be polymeric, metallic or ceramic in nature.

The invention is described by the following examples.

### EXAMPLE 1

A solid solution corresponding to the formula ZrTaO₃N was prepared by precipitation using an alkoxide route starting with ZrO₂ and TaO₂. The solid solution was filtered from the liquid and dried. The filtrate was nitrided by heating at 1000° C. in an ammonia atmosphere. The resulting powder was placed in a die and sintered at 1400° C. under a pressure of 30 MPa to produce a compact. After crushing the compact to a powder of approximately 2 to 10 microns, the powder was nitrided again at 1000° C. in an ammonia atmosphere to ensure that the required oxynitride had been formed. The nitrided powder was placed in a reaction vessel which was placed in the reaction zone of a multi-anvil press. The reaction vessel was raised to a pressure of about 10 GPa and a temperature of about 1500° C. An ultra hard material having the chemical formula ZrTaO₃N was recovered from the reaction vessel. The material has a crystallographic structure in which the average anion co-ordination number was 6.

### EXAMPLE 2

The nitrided powder of Example 1 was subjected to a shock wave treatment. The powder was examined using x-ray diffraction. Analysis of the resulting diffractogram showed that structure had been transformed into an orthorhombic structure, that is, from a crystallographic structure in which the average anion co-ordination number is less than 6 to a crystallographic structure in which the average anion co-ordination number has increased up to a 9-fold co-ordination—the increased co-ordination resulting in enhanced material hardness.

### EXAMPLES 3 AND 4

The procedures set out in Examples 1 and 2 were repeated with a source material, TaON, in place of the source material used in these examples. A TaON hard material was produced having an average anion coordination number of 6, using the conditions of Example 1, and an average anion coordination number of about 9, using the conditions of Example 2.

1. An ultra-hard material comprising at least three elements and having the formula:
Rₓ O_{y}N_{Z}
having a crystallographic structure in which the average anion co-ordination number is 6 or more and wherein:
R is an element selected from the group consisting of titanium, hafnium, zirconium, tantalum, niobium and tungsten,
x is an integer from 1 to 3,
y is an integer from 0 to 5, and
z is an integer from 0 to 5;
provided y and z cannot both be zero.

2. An ultra-hard material of claim 1 wherein R comprises two or more of elements.

3. An ultra-hard material of claim 1 or claim 2 wherein R is tantalum, zirconium or both of these elements.

4. An ultra-hard material of any one of the preceding claims which has a crystallographic structure in which the average anion co-ordination number is about 8 or about 9.

5. An ultra-hard material according to any one of the preceding claims which is TaON.

6. An ultra-hard material according to any one of the preceding claims which is TaZrᵥO₃N.

7. An ultra-hard material according to any one of the preceding claims which has a Knoop hardness of at least 25 GPa.

8. An ultra-hard material according to any one of claims 1 to 6 which has a Knoop hardness of at least 30 GPa.

9. A method of producing an ultra-hard material according to any one of the preceding claims which includes the steps of:
(i) providing a source material having the composition necessary to produce the desired ultra-hard material, and
(ii) subjecting the source material to elevated temperature and pressure conditions suitable to produce the material.

10. A method according to claim 9 wherein the source material has the general formula RₓO_{y}N₃ wherein R, x, y and z are as defined in claim 1 and this source material is transformed to the ultra-hard material under suitable conditions of elevated temperature and pressure.

11. A method according to claim 9 wherein the source material is a mixture of the components necessary to produce the ultra-hard material.

12. A method according to any one of claims 9 to 11 wherein the conditions of elevated temperature and pressure are a temperature of greater than 500° C. and a pressure higher than 4 GPa.

13. A method according to any one of claims 9 to 11 wherein the conditions of elevated temperature and pressure are a temperature in the range 1000 to 1500° C. and a pressure in the range 5 GPa to 30 GPa.

14. A method according to any one of claims 9 to 12 wherein the conditions of elevated temperature and pressure are created by shock wave treatment.

15. An ultra-hard material substantially as herein described with reference to any one of the examples.

16. A method of producing an ultra-hard material substantially as herein described.
